(19) United States
(12) Patent Application Publication
(10) Pub. No.: US 2009/0120358 A1
(43) Pub. Date: May 14, 2009

(54) Spray coating member having excellent injury resistance and so on and method for producing the same

(75) Inventors: Yoshio Harada, Hyogo (JP); Takema Teratani, Hyogo (JP)

Correspondence Address: GREENBLUM & BERNSTEIN, P.L.C., 1950 ROLAND CLARKE PLACE, RESTON, VA, 20191, US

(73) Assignee: Tocalo Co., Ltd., Hyogo (JP)

(21) Appl. No.: 11/990,760

(22) PCT Filed: Aug. 21, 2006
(86) PCT No.: PCT/JP2006/316788

§ 371 Date: Feb. 21, 2008

(30) Foreign Application Priority Data
Aug. 22, 2005 (JP) 2005-239523

(51) Int. Cl. B05D 1/04; B05C 5/00

(52) U.S. Cl. 118/300; 427/596

(57) ABSTRACT

For the purpose of solving problems inherent to a white Al₂O₃ spray coating, i.e. drawbacks that the injury resistance, corrosion resistance, heat resistance, abrasion resistance and the like are poor and the light reflectance is high because the coating is porous and weak in the bonding force among particles, there are proposed a spray coating member having excellent injury resistance and the like in which a surface of a substrate is covered with a colored Al₂O₃ spray coating of a luminosity lower than grayish white, achromatic or chromatic color.

### TECHNICAL FIELD

This invention relates to a spray coating member being excellent in various properties such as injury resistance, heat mission property, corrosion resistance, mechanical properties and the like as well as a method of producing the same, and more particularly to a technique for forming a colored spray coating with a luminosity lower than grayish white on a surface of a substrate.

### RELATED ART

The spraying method is a surface treating technique wherein a spraying powdery material of a metal, ceramic, cermet or the like is fused by a plasma flame or a combustion flame of a combustible gas and the fused particles are accelerated and blown onto a surface of an objective (substrate) to be sprayed, whereby the fused particles are gradually deposited to form a coating having a certain thickness. In the spray coating formed by such a process, a great difference is caused in the mechanical properties and chemical properties of the coating depending on the strong or weak bonding force among the mutually deposited particles constituting the coating or the presence or absence of non-bonded particles. Therefore, the conventional spraying technique aims at the development that the bonding force among the mutually fused particles through the complete fusion of the spraying powder material is strengthened to diminish the non-fused particles and a large acceleration force is applied to the flying fused particles to generate strong impact energy on the surface of the objective to be sprayed to thereby increase the bonding force between the particles, whereby the porosity is decreased or the adhesion force to the objective to be treated (substrate) is strengthened.

For example, JP-A-H01-139749 proposes a method wherein the bonding force among mutually metal particles is improved or oxide film produced on the surface of the particle, which is a cause of generating pores, is reduced by a plasma spraying process under a reduced pressure of plasma-spraying the metal particles in an argon atmosphere of 50-200 hPa.

According to this technical development could be recently improved the characteristics of the spray coating such as mechanical strength and the like, but there is no technique of improving the heat emission property. Particularly, there is no thinking of improving the characteristics such as heat emission property and the like by adjusting the surface color of the spray coating. In this connection, a typical color of the ceramic spray coating is deep green near to black in, for example, chromium oxide (Cr₂O₃) powder as a spraying powdery material, but when it is subjected to a plasma spraying, a black coating is formed.

Thus, it is typically common that the color of the ceramic spray coating is reproduced as a color of a spray coating formed at a state of the color inherent to the spraying powder material. For example, aluminum oxide (shown by Al₂O₃) indicates white color in the powder material itself but also the spray coating formed by spraying the powder material. Particularly, Al₂O₃ is strong in the chemical bonding force between Al and O₂ as a main component as compared with the other oxide ceramics and indicates a white color even if the coating is formed by a plasma spraying process using a gas plasma flame composed mainly of Ar gas as a heat source (a great amount of electrons are included in the plasma).

In order to improve the bonding force of the porous metallic spray coating or among the mutual spraying particles, there is a method defined according to JIS H8303 (self-fluxing alloy spraying). This method is a re-melting method wherein a spray coating is formed and then only the spray coating is heated above a melting point thereof by oxygen-acetylene flame, a high frequency induction heating process, an electric furnace or the like.

As a method of increasing the bonding force among mutual spraying particles, there is a technique of irradiating electron beams or the like. For example, there are disclosed a method of irradiating electron beams or laser beams onto a metal coating to re-melt the coating for sealing in JP-A-S61-104062, a method of irradiating electron beams onto a surface of a carbide cermet coating or a metal coating to improve the performances of the coating in JP-A-H09-316624, and a method of irradiating short-wavelength light beams onto a ceramic for the formation of an electrical conductive portion to render into a metallic state through detachment of oxygen atom to thereby develop the electric conductivity in JP-H09-048684.

However, these conventional techniques target at the metal coating or carbide cermet coating and are to diminish pores in the coating or improve the adhesiveness, and the method of irradiating the short wavelength light beams onto the ceramic coating is also disclosed for giving the electric conductivity to the coating, but they are not intended to intentionally change the color of the coating.

It seems that the concept of the conventional technique on the electron bema irradiation is based on the premise of the thinking that the electrically conductive coating is required when the spraying material is treated with electron beams as described on paragraph [0011] of JP-A-H09-316624.

Further, JP-A-2002-89607 discloses a method wherein an electron beam heat source is used as a vapor source for heating ZrO₂ based ceramic material in the formation of a heat shield coating for a gas turbine to form a top coat having a columnar structure through PVD process. However, this method is a method for forming ZrO₂ based ceramic layer using the electron beam heat source, and is not a technique of re-melting the ceramic coating once formed.

### DISCLOSURE OF THE INVENTION

The conventional Al₂O₃ spray coating is typically a white color inherent to the color of the spraying power material. As the inventors' experience, it is actual that this spray coating does not sufficiently correspond to the demand required in the field of recent sophisticated industry. That is,

(1) In the white Al₂O₃ spray coating, the bonding force among Al₂O₃ particles is weak, and hence if the coating is subjected to shock from exterior such as blast erosion or the like, the particles are apt to be locally fallen down and hence the damage resistance of the coating is deteriorated from the fall-down portion as a starting of the breakage of the whole coating.

(2) The white Al₂O₃ spray coating is high in the light reflection ratio and could not be said to be suitable as a coating member in the field requiring the good heat emission ratio.

(3) Since colored particles are adhered to the white spray coating under environments of the members used requiring a high cleanness as in an interior of the semiconductor processing apparatus, it is required to repeat the cleaning at a frequency exceeding the given times, which brings about the decrease of operation efficiency and the rise of product cost.

(4) The white Al₂O₃ spray coating is a porous coating having a weak bonding force among the mutual particles and many voids (pores) because the contact area among the spraying particles constituting the coating are small. Therefore, although the Al₂O₃ particles themselves have an excellent corrosion resistance, environmental corrosive components (for example, water, acid, salts, halogen gas and so on) are easily penetrated into the pores of the coating and hence the corrosion of the substrate or the peeling of the coating are easily caused.

(5) The white Al₂O₃ spray coating is porous and has a weak bonding force among the particles and does not frequently pass through sufficient melting phenomenon in a hot spraying source. Therefore, it is easily etched during plasma etching or plasma cleaning treatment under an environment including fluorine gas, O₂ gas, fluoride gas or the like, and the durable life become short. Further, the coating particles after the plasma etching render into fine particles, which contaminate the environment and bring about the deterioration of the quality in the semiconductor product.

(6) Furthermore, the white Al₂O₃ spray coating can not be subjected to precision work because the bonding force among the mutual particles constituting the coating is weak and the particles are frequently fallen down in the mechanical work of the coating.

The invention is developed in view of the above-mentioned problems of the conventional techniques and is to provide a spray coating member of a composite oxide having an excellent injury resistance but also mechanical properties such as heat emission property, abrasion resistance and the like, chemical properties such as corrosion resistance and the like, resistance to plasma etching and so on.

The invention propose a spray coating member and a method of producing the same, which have the following summary and construction by further improving the conventional Al₂O₃ spray coating.

(1) A spray coating member having an excellent injury resistance and the like, which comprises a substrate and a colored spray coating of Al₂O₃ having a luminosity lower than grayish white (5Y 9/1) and achromatic (e.g. pearl gray N-7 or the like) or chromatic color (e.g. sand color 2.5Y 7.5/2 or the like) covering the surface of the substrate.

(2) A spray coating member having an excellent injury resistance and the like, wherein an undercoat made of a metal/alloy or cermet spray coating is disposed between the surface of the substrate and the colored spray coating.

(3) A spray coating member having an excellent injury resistance and the like, wherein the colored spray coating has a color formed by decreasing a luminosity of white color (about N-9.5) inherent to the spraying powder material or further changing hue and chromaticity to achromatic or chromatic color deeper than grayish white (5Y 9/1) through electron beam irradiating treatment or laser beam irradiating treatment.

(4) A spray coating member having an excellent injury resistance and the like, wherein the colored spray coating has a thickness of 50-2000 μm based on the deposition of Al₂O₃ spraying particles.

(5) A spray coating member having an excellent injury resistance and the like, wherein a portion of the colored spray coating ranging from the surface to less than 50 μm is a layer solidified after the re-melting through the electron beam irradiation or laser beam irradiation.

(6) A spray coating member having an excellent injury resistance and the like, wherein the undercoat is a spray coating of 50-500 μm in thickness made from at least one metal or an alloy selected from Ni and an alloy thereof, Mo and an alloy thereof, Ti and an alloy thereof, Al and an alloy thereof and Mg alloy, or a cermet of such a metal or alloy with a ceramic.

(7) A method of producing a spray coating member having an excellent injury resistance and the like, which comprises spraying a Al₂O₃ spraying powder material having a white color directly onto a surface of a substrate or onto a surface of an undercoat formed on the surface of the substrate, and then subjecting a surface of the thus obtained white Al₂O₃ spray coating to an electron beam irradiation or laser beam irradiation to change the color of the spray coating surface into an achromatic or chromatic color of a luminosity lower than grayish white (5Y 9/1).

(8) A method of producing a spray coating member having an excellent injury resistance and the like, wherein a layer of less than 50 μm located inward from the surface of the white Al₂O₃ spray coating is changed into an achromatic or chromatic color of a luminosity lower than grayish white (5Y 9/1) through the electron beam irradiation or the laser beam irradiation.

In the invention, the white Al₂O₃ spray coating is basically excellent in various properties, for example, resistance to plasma erosion in an atmosphere of a halogen or halogen compound gas, so that it can be preferably used as a member for recent semiconductor processing apparatus requiring a precise working accuracy and a clean environment, and hence it can largely contribute to improve the quality and productivity of semiconductor processed products. In addition, according to the invention, the surface color of the spray coating is rendered into a hue of sand color (2.5Y 7.5/2) or ash gray (2.5Y 6/1) and hence the injury resistance and the heat emission property are excellent, while when it is particularly subjected to the electron beam irradiation or laser beam irradiation, the surface of the coating becomes smooth and the Al₂O₃ spraying particles constituting the coating are fused together to form a dense coating, and hence the sliding property, corrosion resistance, abrasion resistance and the like are considerably improved, and it is possible to use the coating as a product in industrial fields over a long time.

Further, the colored Al₂O₃ spray coating according to the invention is desirable as a protection coating for a heating heater and the like requiring high heat emission property and heat receiving efficiency.

Moreover, according to the invention, the spray coating members having the above-mentioned properties can be advantageously produced by adopting the electron beam irradiation or laser beam irradiation.

### BRIEF DESCRIPTION OF THE DRAWINGS

FIG. 1(a) is a photograph of a white Al₂O₃ spray coating formed by an atmospheric plasma spraying method of white Al₂O₃ powder material, and FIG. 1 (b) is a photograph of a colored Al₂O₃ spray coating formed by irradiating electron beams to the surface of the white Al₂O₃ spray coating to change into a sand color.

FIG. 2(a) is an optical microphotograph of a surface of Al₂O₃ spray coating after electron beam irradiation and FIG. 2(b) is an optical microphotograph of a section thereof.

FIG. 3(a) is a schematic view of a section of Al₂O₃ spray coating before electron beam irradiation and FIG. 3(b) is a schematic view after electron beam irradiation.

FIG. 4(a) is TEM photograph and crystal structure image of Al₂O₃ spray coating before electron beam irradiation and FIG. 4(b) is TEM photograph and crystal structure image after electron beam irradiation.

FIG. 5(a) is an X-ray diffraction pattern of Al₂O₃ spray coating before electron beam irradiation and FIG. 5(b) is an X-ray diffraction pattern after electron beam irradiation.

### BEST MODE FOR CARRYING OUT THE INVENTION

In the invention, it is one of features that a white (N-9.5) coating inherent to an alumina (Al₂O₃) spraying powder material and a spray coating obtained by spraying this material is rendered into Al₂O₃ spray coating of achromatic (<N-9) or chromatic (<V-9) color (a value of a luminosity is small, low luminosity) deeper than grayish white (5Y 9/1). That is, the color of the spraying powder material (inherent color) is about N-9.5 (white or snow white) as Munsell system. However, the invention provides a spray coating having a color (color of small luminosity value) deeper than grayish white (5Y 9/1), for example, achromatic color such as pearl gray (N-7.0) or dull color (N-4.0), or a chromatic color with a luminosity of Munsell system of not more than V-8.5 (corresponding to N-8.5) which is a luminosity of ivory, more preferably not more than V-7.5, such as sand color (2.5Y 7.5/2), sky gray (7.5B 7.5/0.5), ash color (2.5Y 6/1), leaden color (2.5PB 5/1) or the like.

These colors can be realized by controlling the irradiation of electron beams or laser beams to a spray coating as mentioned later. Hereinafter, the spray coating added with the above color in the invention is called as a colored spray coating as compared with the inherent color spray coating (white).

Next, the production method of the colored Al₂O₃ spray coating of ivory or the like suitable for the invention will be described and also the features of the colored composite oxide spray coating will be explained.

(1) Method of producing members by formation of Al₂O₃ spray coating

The Al₂O₃ spray coating is formed by roughening a surface of a body to be sprayed (substrate) through a blast treatment and applying a commercially available white Al₂O₃ spraying powder material directly onto the surface thereof or onto a surface of an undercoat made of a metal or an alloy or a cermet firstly formed on the surface of the substrate through a plasma spraying method or the like. The appearance of the spray coating is initially a white base coating likewise the spraying powder material.

In the invention, a spraying method such as an atmospheric plasma spraying method, a plasma spraying method under a reduced pressure, a high-speed flame spraying method, an explosion spraying method, a water plasma spraying method using water as a plasma source or the like can be applied to the formation of Al₂O₃ spray coating sprayed on the surface of the substrate. All of the appearances of Al₂O₃ spray coatings formed by these spraying methods are a white color system.

In the formation of the Al₂O₃ spray coating according to the invention, the undercoat is first formed on the surface of the substrate and then the coating may be formed thereon. In this case, it is preferable that at least one metal/alloy selected from Ni and an alloy thereof, Mo and an alloy thereof, Ti and an alloy thereof, Al and an alloy thereof and Mg alloy or a cermet with ceramics thereof is used as a material for the undercoat and is applied at a thickness of about 50-500 μm.

The undercoat plays a role for blocking the surface of the substrate from corrosive environment to improve the corrosion resistance but also improve the adhesion property between the substrate and Al₂O₃-Y₂O₃ composite oxide. Therefore, when the thickness of the undercoat is less than 50 μm, the action mechanism as the undercoat (chemical protection action for the substrate) is weak but also the uniform formation of the coating is difficult, while when the thickness of the undercoat exceeds 500 μm, the coating effect is saturated and the lamination working time is increased to bring about the rise of the production cost.

Also, the thickness of the Al₂O₃ spray coating always being a top coat is preferably within a range of about 50-2000 μm. When the thickness is less than 50 μm, the equality of the coating thickness is lacking and also the functions as the oxide ceramic coating, for example, resistance to erosion, resistance to plasma erosion, durability and the like can not be developed sufficiently. While, when the thickness exceeds 2000 μm, the bonding force among mutual particles constituting the coating becomes further weak and also the residual stress of the coating becomes large, and hence the strength of the coating itself lowers and the coating is easily broken even though the action of slight external force.

As the spraying powder material in the invention, powder having a particle size range of 5-80 μm formed by pulverizing the above alumina is used. When the particle size of the powder material is less than 5 μm, since the powder has no fluidity, it could not be evenly supplied to a spraying gun and the thickness of the spray coating becomes unequal. While, when the particle size exceeds 80 μm, the material is not completely fused in a spraying hot source, and hence the resulting coating becomes porous and the bonding forces among the mutual particles and adhesion force to the substrate become weak and the coating quality becomes rough, the bonding force to the substrate and the undercoat is undesirably deteriorated.

The substrate for the formation of the spray coating could be Al and Al alloy, corrosion-resistant steel such as stainless steel, Ti and an alloy thereof, ceramic sintered bodies (for example, oxide, nitride, boride, silicide, carbide and a mixture thereof), and raw materials such as quartz, glass, plastics and the like. Various plated layers or vapor deposit layer formed on these raw materials could be also used.

(2) Electron beam or laser beam irradiation treatment for coloration of Al₂O₃ spray coating

According to the invention, electron beams or laser beams (hereinafter referred to as “electron beam or the like) are irradiated to the white Al₂O₃ spray coating having the same color as the Al₂O₃ spraying powder material. The electron beam irradiation treatment is a treatment for fusing Al₂O₃ particles on the surface of the coating together to conduct densification and also changing the color of the coating surface from white to at least ivory (2.5Y 8.5/1.%), preferably ash color (2.5Y 6/1), and it is applied for rendering the surface layer portion of the spray coating from white (N-9.5) to an achromatic color (N-9.0) having a slightly small N-value or a deeper chromatic color (grayish white: 5Y 9/1, ivory: 2.5Y 8.5/1.5 or the like).

Also, in the irradiation treatment of electron beam or the like, the surface layer portion of the Al₂O₃ spraying particles changed into ivory color is locally at a fused state through the irradiation of the beam, so that the coating surface tends to be smoothened as a whole. Further, in the formation of the spray coating, such factors could be eliminated as local particle dropout, increase of porosity and deterioration of corrosion resistance and abrasion resistance resulted from the presence of Al₂O₃ particles deposited at an unmolten state because the heating is not sufficiently conducted due to the lacking of a spray heat source.

Since the fusion and densification phenomenon of the spray coating are gradually extended from the surface into the inside by increasing the irradiation number of electron beam or the like, or prolonging the irradiation time, or increasing the output thereof, it is possible to control the molten depth by changing these conditions. Moreover, when the molten depth is practically about 50 μm, the coatings suitable for the object of the invention could be obtained.

As the condition for electron beam irradiation, the following conditions after an inert gas (Ar gas or the like) is introduced into an irradiation chamber discharging air are recommended, but not necessarily fulfilled if the irradiation effect can be obtained up to a depth of 50 μm from the surface of the spray coating.

Irradiating atmosphere: 10-0.0005 Pa
Irradiating power output: 0.1-8 kW
Irradiating speed: 1-30 m/s

As the irradiation of the laser beams, it is possible to use YAG laser utilizing YAG crystal, or CO₂ gas laser or the like. As the laser beam irradiation treatment, the following conditions are recommended, but not necessarily fulfilled if the irradiation effect can be obtained up to a depth of 50 μm from the surface of the spray coating likewise the above-mentioned case.

Laser power output: 0.1-10 kW
Laser beam area: 0.01-2500 mm²
Irradiating speed: 5-1000 mm/s

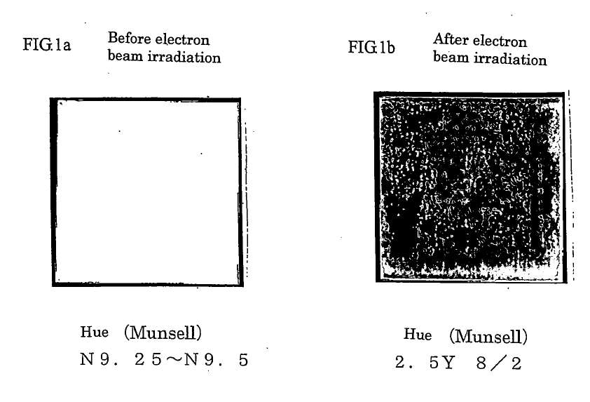

FIG. 1 shows an appearance (a) of a white Al₂O₃ spray coating obtained by an atmospheric plasma spraying and an appearance (b) of a colored spray coating after electron beams are irradiated to the surface of the white spray coating, respectively.

Moreover, FIG. 1(a) shows that an atmosphere plasma is sprayed onto an aluminum substrate (A5052) having a width×length×thickness of 50×50×10 mm to form an Al₂O₃ spray coating having a thickness of 250 μm, which is then subjected to a plane polishing work, and FIG. 1(b) shows that electron beams are irradiated onto the surface of the spray coating of FIG. 1(a) under condition that an acceleration voltage is 28 kV and that an irradiating atmosphere is <0.1 Pa.

In the illustrated embodiment, the color of the Al₂O₃ spray coating is changed from N-9.25-0.5 (white) to 2.5Y 8/2 by the irradiation of electron beam or the like, which shows substantially sand color (2.5Y 7.5/2) or ash color (2.5Y 6/1).

Moreover, the causes for the color change of the Al₂O₃ spray coating surface irradiated by electron beam or the like are not sufficiently elucidated by the inventors, but they are considered by acting the following facts alone or compositely.

(I) In Al₂O₃ as a spraying powder material, the presence of slight amount of impurities contributes to coloration by subjecting to a heating and melting action through many electrons under a condition that an oxygen partial pressure is low as in the irradiation atmosphere of electron beam or the like.
(II) A part of a metallic member disposed in an irradiation chamber for electron beam or the like is changed into a slight amount of a colored fine dust by subjecting to the irradiation of electron beam or the like, which is incorporated into the molten surface of the spray coating.
(III) A part of oxygen in Al₂O₃ is locally removed to change into Al₂O₃₋ₓ by irradiating many electrons having a low oxygen partial pressure and a strong reducing property in an irradiating atmosphere of electron beam or the like. However, the coloration of the white Al₂O₃ spray coating by the irradiation of electron beam or the like is obtained at a probability of 100% under the above irradiation conditions.

(3) Outline of appearance and section of Al₂O₃ spray coating subjected to irradiation of electron beam or the like

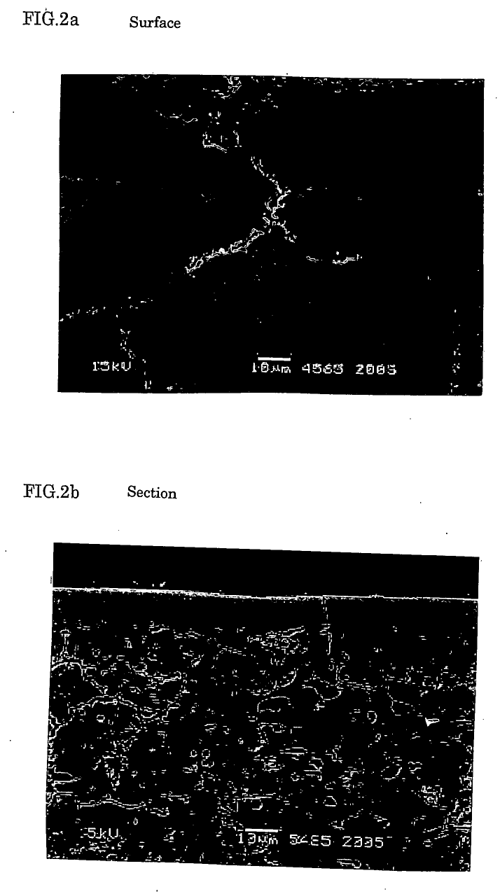

As the inventors' studies, the appearance of Al₂O₃ spray coating subjected to the irradiation treatment of electron beam or the like changes into a color such as grayish white, ivory, sand color, ash color or the like, while as the surface and section are observed by using an optical microscope (SEM-BEI image), small cracks were found in a network form (FIGS. 2(a), (b)). It is considered that the network-shaped cracks are generated when Al₂O₃ particles melted by irradiation of electron beam or the like are fused with each other to form a large smooth face and thereafter the volume is shrunk at the cooling stage. As seen from the section view of FIG. 2(b), the cracks generated on the surface of the Al₂O₃ coating and resulted from the heat shrinkage after the electron beam irradiation are limited to the surface and do not penetrate into the interior of the coating, so that they do not exert on the corrosion resistance of the coating. Moreover, crack-free irradiated face may be formed by pre-heating the irradiated portion or by slowly cooling after the irradiation.

On the other hand, a coating structure having many pores, which is inherent to the Al₂O₃ spray coating, remains in the underlayer portion below the electron beam irradiating influenced portion (portion of the coating changed by irradiation), so that such a coating structure is considered to advantageously act to thermal shock.

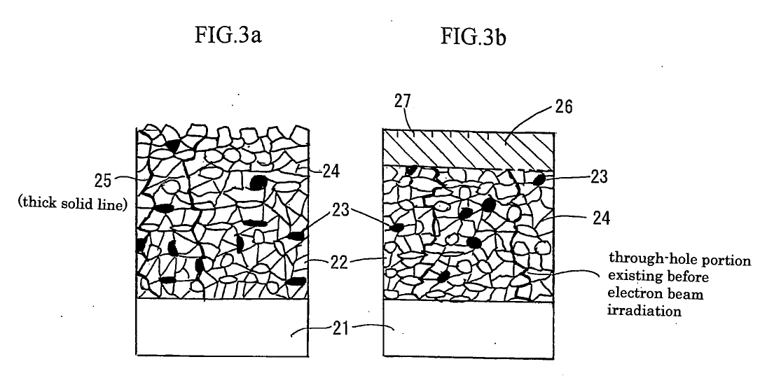

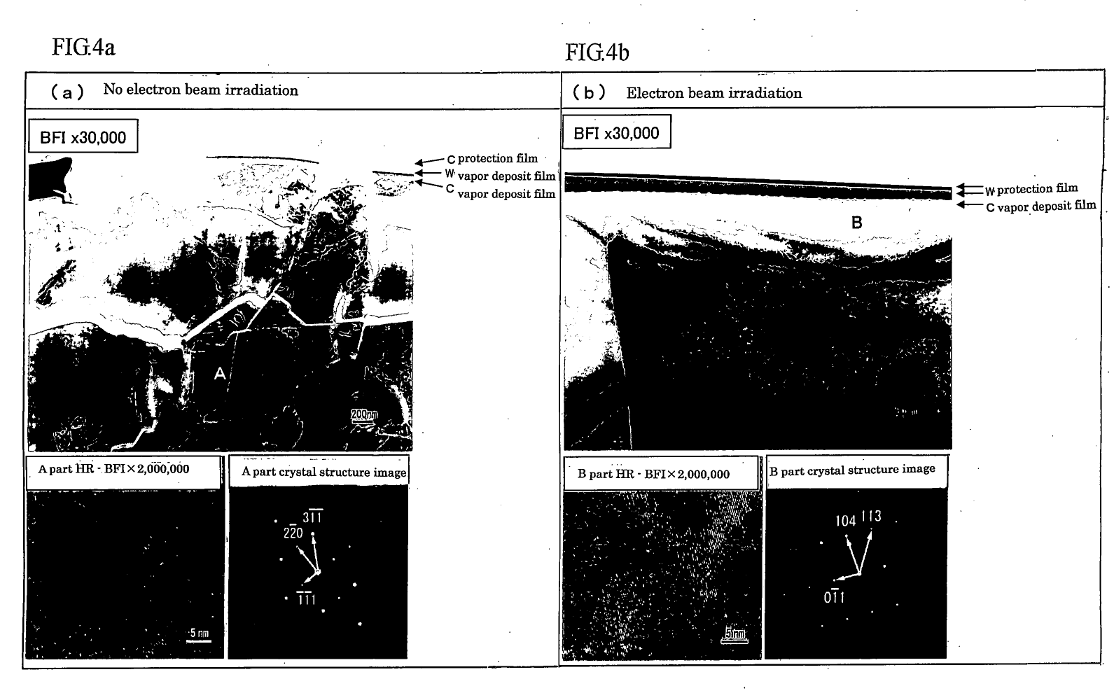

FIG. 3 schematically shows section states of a spray coating before and after electron beam irradiation (a) and (b), and further FIG. 4 shows TEM photographs and crystal structure images of Al₂O₃ spray coating section before and after electron beam irradiation (a) and (b), respectively. In the non-irradiated portion shown in FIGS. 3(a) and 4(a), the particles constituting the coating are independently deposited in the form of stone wall, and the surface roughness becomes large and the presence of various big and small gaps (pores) is observed. On the other hand, in the irradiated portion shown in FIGS. 3(b) and 4(b), a new layer having different microstructure is formed on the spray coating of the Al₂O₃-Y₂O₃ composite oxide particles. This layer is a dense layer having less gaps by fusing the spraying particles with each other.

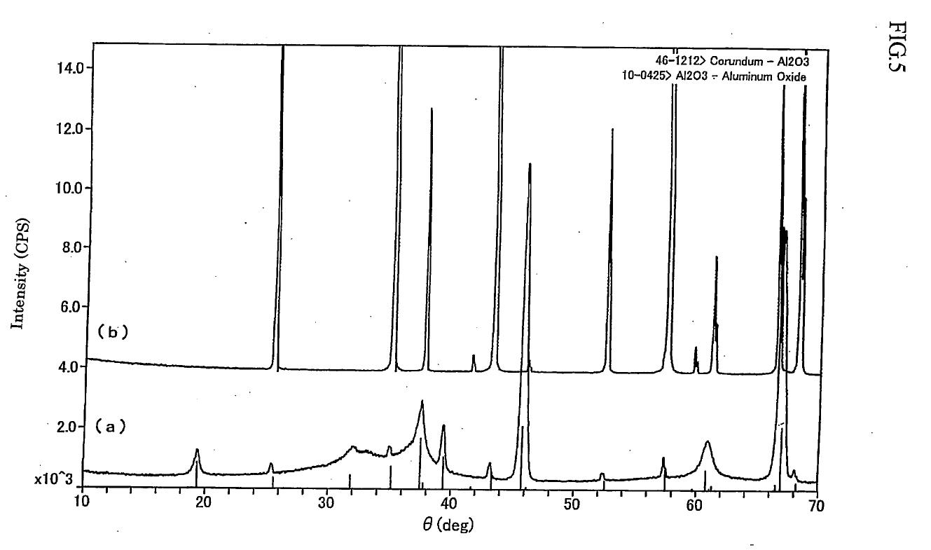

Furthermore, it is understood from the crystal structure image of FIG. 4 that the crystal form of Al₂O₃ particles constituting the coating is γ-Al₂O₃ (cubic system spinel) before the electron beam irradiation and is transformed into α-Al₂O₃ (trigonal system steel beads type) by the electron beam irradiation. In addition, the crystal structures of the Al₂O₃ spray coating before electron beam irradiation and after electron beam irradiation are conformed by X-ray diffraction (FIG. 5). As a result, it can be confirmed that the crystal form of Al₂O₃ particles in the coating is transformed from γ-type to α-type to improve the stability of the particles by electron beam irradiation.

Moreover, numeral 21 in FIG. 3 is a substrate, numerals 22 are Al₂O₃ particles constituting the coating, numerals 23 are gap portions of the coating, numerals 24 are grain boundary portions of Al₂O₃ particles, numeral 25 is a through-pore portion along the grain boundary, numeral 26 is a fused portion of Al₂O₃ particles through electron beam irradiation, and numerals 27 are fine heat-shrinkage cracks generated in the fused portion of Al₂O₃ particles.

(4) Features of Al₂O₃ spray coating irradiated by electron beam or the like

The colored Al₂O₃ spray coating according to the invention possesses the following functions without damaging physical and chemical properties of the conventional typical white Al₂O₃ spray coating formed by plasma spraying or the like (for example, it is hard and excellent in the abrasion resistance and has corrosion resistance and electric insulating property).

(a) The surface of the colored Al₂O₃ spray coating irradiated by electron beam or the like is completely melted once and integrally united by fusing Al₂O₃ particles of about 5-80 μm constituting the coating with each other, so that the mechanical strength in the vicinity of the surface of the spray coating (from the surface up to a depth of 50 μm) is improved and hence. the coating is hardly broken.

(b) The surface of the colored Al₂O₃ spray coating is considerably smoothened by the irradiation of electron beam or the like because the maximum roughness (Ry) of the surface before the irradiation treatment is 16-32 μm but the maximum roughness (Ry) after the irradiation treatment becomes about 6-18 μm owing to the melting phenomenon, and hence unmelted particles inherent to the spray coating or composite oxide particles convexly adhered thereto are discreated to improve the sliding property. Also, the mechanical working precision of the spray coating surface is improved, whereby spray coating members having a high precision could be produced.

(c) In the surface of Al₂O₃ spray coating irradiated by electron beam or the like, pores existing in the spray coating, particularly through-holes passing from the surface of the coating to the substrate are come off by the melting phenomenon, so that the corrosion resistance of not only the coating but also the substrate are improved dramatically.

(d) As previously mentioned, the Al₂O₃ spray coating irradiated by electron beam or the like changes from white color (N-9.5) just after the spraying into a color such as ivory (2.5Y 8.5/1.5) or the like, and hence light reflectance lowers and absorption efficiency of radiant heat is improved, so that a new evolution to members utilizing the change of color tone could be expected.

(e) In the surface of Al₂O₃ spray coating irradiated by electron beam or the like, the resistance to plasma erosion is considerably improved by the actions and effects of the above items (a)-(d). Therefore, when the colored Al₂O₃ spray coating irradiated by electron beam or the like according to the invention is applied to a surface of a member for semiconductor production-inspection-working apparatus requiring the clean environment, the resistance to plasma erosion is improved and the phenomenon of generating particles as an environmental contamination source lowers. As a result, the invention develops the remarkable effect in the maintenance of environment cleanness and largely contributes to the improvement of the productivity accompanied with the decrease of cleaning number of the apparatus.

(f) By the irradiation treatment of electron beam or the like, the crystal form of Al₂O₃ particles constituting the coating from γ-Al₂O₃ (cubic system spinel) are transformed to α-Al₂O₃ (trigonal system steel beads type) to improve the stability of the particles at a crystal level.

(5) Thermal spectral properties of colored Al₂O₃ spray coating In the colored Al₂O₃ spray coating changed into a sand color (2.5Y 7.5/2) by the method of the invention, the thermal spectral properties change largely. This is clear from the following experiment conducted by the inventors. That is, a surface of a test piece of SUS 304 steel (size: width 30 mm×length 50 Mm×thickness 3.2 mm) is subjected to a blast treatment and then a spray coating of 120 μm in thickness is directly formed on such a surface by using white Al₂O₃ powder material through an atmospheric plasma spraying method. Thereafter, the surface of the spray coating is changed into a sand color by electron beam irradiation.

With respect to the thus obtained Al₂O₃ spray coating as a sample, spectral properties on wavelengths of 0.34-4 μm belonging to a range of visible zone to near-infrared zone are measured by using a Hitachi 323 model ultraviolet-visible spectrophotometer integrating sphere (for the measurement of diffuse reflection). In this measurement, since the sample is opaque, the absorption ratio (a) is determined according to the following equation by actually measuring the reflectance (γ) when the permeability is zero:

Absorption ratio (α)=1−γ

Table 1 shows the test results. Since the white spray coating reflects greater part of the wavelengths to be tested, the absorption ratio (a) is about 0.05-0.1, while in the Al₂O₃ spray coating changed into sand color, the absorption ratio rises dramatically and shows 0.4-0.6. As compared with a case that an absorption ratio of Cr₂O₃ black spray coating used as a comparative example is about 0.9-0.92, it has been found that the spectral properties are largely influenced even in the sand color belonging to a slight coloration.

TABLE 1

| | | | Presence or | | | Spectral | |
|---|---|---|---|---|---|---|---|
| | | | absence of | Appearance color of coating | | properties | |
| | | Spray coating | electron beam | before | after | (absorption | |
| No. | Substrate | material | irradiation | irradiation | irradiation | ratio α) | Remarks |
| 1 | SUS 304 | Al₂O₃ | absence | white | — | 0.05-0.1 | Comparative |
| | | | | | | | Example |
| 2 | | | presence | white | sand color | 0.4-0.6 | Invention |
| | | | | | | | Example |
| 3 | | Cr₂O₃ | absence | black | black | 0.9-0.92 | Comparative |
| | | | | | | | Example |

(Note)
(1) The spray coating material is a commercially available material having a purity of not less than 98.0 mass % for both Al₂O₃ and Cr₂O₃.
(2) The thickness of the thermally molten layer in the coating through electron beam irradiation is 2-3 μm.
(3) As to the spectral properties, the absorption ratio (α) is determined according to the following equation by actually measuring the reflectance (γ) by means of a Hitachi 323 model ultraviolet-visible spectrophotometer integrating sphere under condition of wavelength: 0.34-4 μm:
Absorption ratio (α) = 1 − γ

### EXAMPLES

### Example 1

After a one-side surface of SS400 steel test piece (size: width 50 mm×length 100 mm×thickness 3.2 mm) was subjected to a blast treatment, an Al₂O₃ spraying powder material was directly sprayed on the treated surface by an atmospheric plasma spraying method to form a spray coating of 150 μm in thickness. Thereafter, the surface of the Al₂O₃ spray coating was subjected to an electron beam irradiation treatment. In this case, spray coatings had been provided wherein the influence of electron beam irradiation was located at a distance from the surface of 3 μm, 5 μm, 10 μm, 20 μm, 30 μm or 50 μm by changing electric output of the electron beam irradiation, irradiation number and the like to control the molten state (melting depth) of Al₂O₃ particles on the surface of the spray coating.

Onto the exposed part of the substrate such as side face and rear face of the test piece after the electron beam irradiation, a paint having a corrosion resistance was applied, which was subjected to a slat spray test defined according to JIS Z2371 to examine the corrosion resistance of the spray coating.

Further, as Al₂O₃ spray coating of Comparative Example, an atmospheric plasma spray coating not irradiated by electron beams was subjected to the slat spray test.

Moreover, the electron beam irradiation apparatus used in this example had the following specifications.

Output of electron beams: 6 kW
Acceleration voltage: 30-60 kV
Beam current: 5-100 mA
Beam diameter: 400-1000 μm
Irradiation atmosphere pressure: 6.7-0.27 Pa
Irradiation distance: 300-500 mm

Table 2 summarizes the results of the salt spray test. As seen from these results, many pores inherent to the ceramic spraying were existent in the Al₂O₃ spray coating of the comparative example (No. 1), so that red rust was generated over the full surface of the test piece after 24 hours, and the subsequent test had been stopped.

On the contrary, the occurrence of red rust had not been observed in the test pieces irradiated by electron beams (No. 2 - No. 7) after 48 hours. Only in the test pieces (No. 2 and No. 3) having a thin thickness of molten layer on the surface of the coating through the electron beam irradiation, the occurrence of small red rust had been first observed in 2-3 places after the 96 hours, while the other test pieces did not show the occurrence of red rust at all.

As seen from the above results, it had been found that the Al₂O₃ spray coating irradiated by electron beams was melted and fused together at its surface by electron beams to completely eliminate pores existing in the coating, particularly a part of through-holes extending to the substrate, which prevented salt water from arriving at the surface of the substrate through the interior of the coating.

Moreover, micro-cracks were existent even at the electron beam irradiated faces, but these cracks were found to be generated only on the surface portion when the molten Al₂O₃ spraying particles became shrunk by cooling and not a large crack extending to the substrate, therefore not affecting the corrosion resistance of the coating.

TABLE 2

| | | | Presence or absence of | | | | | |
|---|---|---|---|---|---|---|---|---|
| | | | electron beam irradiation and | | | | | |
| | | Spray | influence depth thereof | | | | | |
| | | coating | presence or | Influence | Results of salt spray test | | | |
| No. | Substrate | material | absence | depth μm | after 24 h | after 48 h | after 96 h | Remarks |
| 1 | SS400 | Al₂O₃ | absence | — | x | not carried | not carried | Comparative Example |
| | | | | | | out | out | |
| 2 | | | presence | 3 | ∘ | ∘ | Δ | Invention Example |
| 3 | | | presence | 5 | ∘ | ∘ | Δ | Invention Example |
| 4 | | | presence | 10 | ∘ | ∘ | ∘ | Invention Example |
| 5 | | | presence | 20 | ∘ | ∘ | ∘ | Invention Example |
| 6 | | | presence | 30 | ∘ | ∘ | ∘ | Invention Example |
| 7 | | | presence | 50 | ∘ | ∘ | ∘ | Invention Example |

(Note)
(1) The thickness of the spray coating is 150 μm.
(2) The slat spray test was carried out according to JIS Z2371.
(3) Symbols in the results of the salt spray test mean the following contents. ∘: no red rust, Δ: occurrence of red rust at less than 3 places, x: occurrence of red rust over full face

### Example 2

In this example, a one-side surface of a test piece of SUS 304 steel (size: width 50 mm×length 60 mm×thickness 3.2 mm) was subjected to a blast treatment, and thereafter a coating was directly formed at a thickness of 150 μm on the surface thereof by spraying white Al₂O₃ particles through an atmospheric plasma spraying method, or an undercoat of 80 mass % Ni-20 mass % Cr alloy was formed at a thickness of 150 μm by an atmospheric plasma spraying and then an Al₂O₃ spray coating as a top coat was formed on the undercoat at a thickness of 150 μm by an atmospheric plasma spraying method. Thereafter, the surfaces of these Al₂O₃ spray coatings were subjected to a densification treatment by irradiating electron beams. Moreover, Al₂O₃ spray coating not irradiated by electron beam was provided as a comparative example and subjected to a thermal shock test under the same conditions to measure occurrence of cracks in the composite oxide spray coating as a top coat and presence or absence of the peeling.

In the thermal shock test, the test piece had been placed in an electric furnace adjusted to 500° C. for 15 minutes and then charged into a tap water of 20° C. This operation was one cycle, and repeated in 5 cycles while the appearance state of the top coat was observed every cycle. The number of the test pieces was three per one condition, and a case that cracks were generated in one test piece is shown by “⅓ crack occurrence”.

Table 3 summarizes the above results. As seen from these results, The Al₂O₃ spray coating formed on the undercoat above the substrate developed good resistance to thermal shock irrespectively of the presence or absence of the electron beam irradiation and defects such as cracks or the like were not observed on the top coat.

On the contrary, in the Al₂O₃ spray coatings directly formed on the substrate as a top coat (No. 1 and 2), when electron beams were not irradiated, cracks were generated in two test pieces among three test pieces (shown by ⅔), so that the resistance to thermal shock was found to be poor.

From these results, it is clear that the densification of the Al₂O₃ spray coating through the electron beam irradiation were limited to be in the vicinity of the surface of the coating and that the interior of the coating was maintained at a state of having many pores. Moreover, it is understood that at least the application of the undercoat had been effective for improving the resistance to thermal shock in these coatings.

TABLE 3

| | | | | Presence or absence of electron | | Results of thermal | |
|---|---|---|---|---|---|---|---|
| | | | | beam irradiation and influence | | shock test (500° | |
| | | | | depth thereof | | C. × 15 min) | |
| | | Spray coating material | | presence or | influence | [symbol] charging into | |
| No. | Substrate | undercoat | top coat | absence | depth (μm) | water, 5 cycles | Remarks |
| 1 | SUS 304 | absence | Al₂O₃ | absence | — | 2/3 crack, | Comparative |
| | | | | | | partly peeling | Example |
| 2 | | | Al₂O₃ | presence | 5 | 1/3 crack | Invention |
| | | | | | | | Example |
| 3 | | presence | Al₂O₃ | absence | — | no crack and | Comparative |
| | | | | | | peeling | Example |
| 4 | | | Al₂O₃ | presence | 5 | no crack and | Invention |
| | | | | | | peeling | Example |
| 5 | | presence | Al₂O₃ | absence | — | no crack and | Comparative |
| | | | | | | peeling | Example |
| 6 | | | Al₂O₃ | presence | 10 | no crack and | Invention |
| | | | | | | peeling | Example |

(Note)
(1) Each of undercoat (80Ni—20Cr) and top coat (Al₂O₃) are formed at a thickness of 150 μm by an atmospheric plasma spraying method.
(2) Meaning of fractional number in column of “Result of thermal shock test”
1/3 means that crack or peeling is caused in one top coat (Al₂O₃) among three test pieces.

### Example 3

In this example a resistance to fluorine gas in the sand-colored Al₂O₃ spray coating irradiated by electron beam was examined. On a one-side surface of a test piece of SUS 304 steel (size: width 30 mm×length 50 mm×thickness 3.2 mm) as a substrate, a white Al₂O₃ spraying powder material in an atmospheric plasma was directly plasma sprayed to form a white Al₂O₃ spray coating having a thickness of 150 μm. Thereafter, the spray coating was melted within a range of 5 μm from the surface and densified by an electron beam irradiation treatment to form a colored spray coating having a sand color.

The test piece having the thus treated colored spray coating was placed in an autoclave wherein air was removed and HF gas was introduced so as to have a partial pressure of 100 hPa, and then the autoclave was heated to 300° C. to conduct a continuous corrosion test of 100 hours. Moreover, the same test was conducted under the same conditions on the substrate (SUS 304) and the white Al₂O₃ spray coating not irradiated by electron beam as a comparative example.

Table 4 shows the results. In No. 1 spray coating (comparative example), the substrate of SUS 304 steel was violently corroded by HF gas to generate fine red rusts over a full face of the test piece. Also, in the white Al₂O₃ spray coating not irradiated by electron beam (No. 2), the coating itself was sound, but was completely peeled off from the substrate of SUS 304 steel, and hence the occurrence of red rust was observed on the surface of the substrate.

From this result, it is considered that the joint force between the substrate and the coating in the Al₂O₃ spray coating not irradiated by electron beam was lost due to the corrosion of the substrate with HF gas penetrated inward through pore portions of the coating.

On the contrary, in the Al₂O₃ spray coatings changed into ivory color by electron beam irradiation, it is considered that the higher corrosion resistance was developed because the through-holes extending to the substrate were very less and the peeling of the coating was not caused though micro-cracks generated in the cooling solidification from the molten state were existent on the surface of the coating irradiated by electron beam.

TABLE 4

| | | | Presence or | | | Result of | |
|---|---|---|---|---|---|---|---|
| | | | absence of | Appearance of coating | | corrosion test | |
| | | Spray coating | electron beam | before | after | HF gas-300° C.- | |
| No. | Substrate | material | irradiation | irradiation | irradiation | 100 h | Remarks |
| 1 | SUS 304 | — | — | — | — | occurrence of | Comparative |
| | | | | | | red rust over | Example |
| | | | | | | full face | |
| 2 | | Al₂O₃ | absence | white | — | peeling of | Comparative |
| | | | | | | coating | Example |
| 3 | | | presence | white | sand color | occurrence of | Invention |
| | | | | | | red rust at one | Example |
| | | | | | | place. | |
| | | | | | | no peeling of | |
| | | | | | | coating | |
| 4 | | | presence | white | sand color | no peeling of | Invention |
| | | | | | | coating | Example |

(Note)
(1) Thickness is 150 μm in atmospheric plasma spraying method.
(2) Thickness of molten layer in the coating through electron beam irradiation is 5 μm.

### Example 4

In this example, resistance to plasma erosion of the colored Al₂O₃ spray coating irradiated by electron beam according to the invention was examined. As an electron beam irradiated test piece, the same as in Example 3 was used, which was subjected to a continuous treatment at a plasma output of 80 W for an irradiating time of 500 minutes using a reactive plasma etching apparatus in an atmosphere consisting of 60 ml/min of CF₄ gas and 2 ml/min of O₂. Moreover, as a test piece of a comparative example, Al₂O₃ spray coating formed by atmospheric plasma spraying and SiO₂ spray coating were tested under the same conditions.

Table shows the test results. The plasma erosion quantity of the Al₂O₃ spray coating as the comparative example was 1.2-1.4 μm, while the erosion quantity of the colored Al₂O₃ spray coating irradiated by electron beam was reduced to 25-40%, from which it is clear that the resistance to erosion had been improved by densification of the surface of the spray coating. Moreover, the SiO₂ coating as another comparative example was easily subjected to a chemical action of CF₄ gas, and showed its erosion quantity as 20-25 μm, which was maximum among those of the tested coatings, from which it is confirmed that the latter coating could not be used under this type of the environment.

TABLE 5

| | | | Presence or absence of electron beam | | | |
|---|---|---|---|---|---|---|
| | | | irradiation and influence depth thereof | | | |
| | | Spray coating | presence or | influence depth | Plasma erosion | |
| No. | Substrate | material | absence | (μm) | depth (μm) | Remarks |
| 1 | SUS 304 | Al₂O₃ | absence | — | 1.2-1.4 | Comparative |
| | | | | | | Example |
| 2 | | | presence | 3 | 0.5-0.75 | Invention |
| | | | | | | Example |
| 3 | | | presence | 10 | 0.4-0.70 | Invention |
| | | | | | | Example |
| 4 | | SiO₂ | absence | — | 20-25 | Comparative |
| | | | | | | Example |

(Note)
(1) Thickness of Al₂O₃ spray coating was 150 μm.
(2) The surface of the spray coating was mirror-polished for the testing.
(3) The erosion depth was measured at three places of the test piece surface and shown by a range of the measured values.

### Example 5

In this example, the abrasion resistance was compared between the Colored Al₂O₃ spray coating showing a sand color (2.5Y 7.5/2) and the spray coating not irradiated by electron beam using the test piece of Example 2. The test apparatus and conditions thereof are as follows.

Test method: reciprocal moving abrasion test method defined according to a test method for abrasion resistance of a plating of JIS H8503 Test conditions: load of 3.5 N, 10 minutes (400 times) and 20 minutes (800 times) at a reciprocal speed of 40 times/min, abrasive area 30×12 mm, abrasion test paper CC320

The evaluation was conducted by measuring weights of the test piece before and after the test and quantifying an abrasion quantity from the difference thereof.

Moreover, a case that the Al₂O₃ atmospheric plasma spray coating was not subjected to an electron beam irradiation is shown as a comparative example in this test (No. 1).

The test results are shown in Table 6. As seen from the results, the sand-colored Al₂O₃ spray coatings (No. 2 and 3) as an invention example developed an excellent abrasion resistance suitable for the invention because the weight reduction quantity associated with the abrasion was about 40-50% of the abrasion quantity of the comparative example. Moreover, this result is considered to include the improvement of smoothness on the surface of t he coating through electron beam irradiation, bonding force among mutual Al₂O₃ particles constituting the coating, and so on.

TABLE 6

| | | | | Presence or absence of | | | | | |
|---|---|---|---|---|---|---|---|---|---|
| | | | | electron beam irradiation | | | | | |
| | | | | and color of coating | | | Weight reduction quantity | | |
| | | Appearance | Presence or | presence or | | | by abrasion test (mg) | | |
| | Spraying | color of | absence of | absence of | appearance | Porosity of | after 400 | after 800 | |
| No. | method | coating | undercoat | irradiation | color | coating (%) | times | times | Remarks |
| 1 | Atmospheric | white | presence | absence | white | 3-8 | 38-57 | 72-91 | Comparative |
| | plasma | | | | | | | | Example |
| 2 | spraying | white | presence | Presence | sand color | 0.1-0.3 | 18-30 | 30-38 | Invention |
| | | | | (3 μm) | | | | | Example |
| 3 | | white | presence | Presence | sand color | 0.1-0.2 | 18-28 | 28-39 | Invention |
| | | | | (5 μm) | | | | | Example |

(Note)
(1) Three test pieces per one test, numeral in the column of “presence or absence of electron beam irradiation” shows a thickness of molten layer in the coating.
(2) In the coating, thickness of undercoat (80Ni—20Cr) is 100 μm and thickness of Al₂O₃—Y₂O₃ composite oxide as a top coat is 180 μm.
(3) The porosity of the coating was measured by an image analyzing apparatus for coating section.
(4) The abrasion-resistant test of the coating was carried out by a reciprocal moving abrasion test method defined according to a test method for abrasion resistance of a plating of JIS H8503.

### INDUSTRIAL APPLICABILITY

The technique of the invention can be widely utilized in industrial fields of using Al₂O₃ spray coatings. Also, the technique of the invention could be used as a protection coating for a heater or a coating for a heat receiving plate because the effect of absorbing radiant heat is high. Furthermore, the technique of the invention is effectively used as a material for precision machine parts because the flat plane property based on the fusion bonding of particles constituting the spray coating formed on the surface of the substrate is excellent and the surface precision finish through mechanical work is possible. Moreover, it is preferably used as a protection technique for members in semiconductor working-producing-inspecting apparatus or members in liquid crystal producing apparatus which conduct plasma etching reaction in a gas atmosphere of a halogen or a halogen compound.

1. A spray coating member having an excellent injury resistance and the like, which comprises a substrate and a colored spray coating of Al₂O₃ having a luminosity lower than grayish white and achromatic or chromatic color covering the surface of the substrate.

2. A spray coating member having an excellent injury resistance and the like according to claim 1, wherein an undercoat made of a metal/alloy or cermet spray coating is disposed between the surface of the substrate and the colored spray coating.

3. A spray coating member having an excellent injury resistance and the like according to claim 1, wherein the colored spray coating has a color formed by decreasing a luminosity of white color inherent to the spraying powder material or further changing hue and chromaticity to achromatic or chromatic color deeper than grayish white through electron beam irradiating treatment or laser beam irradiating treatment.

4. A spray coating member having an excellent injury resistance and the like according to claim 1, wherein the colored spray coating has a thickness of 50-2000 μm based on the deposition of Al₂O₃ spraying particles.

5. A spray coating member having an excellent injury resistance and the like according to claim 1, wherein a portion of the colored spray coating ranging from the surface to less than 50 μm is a layer solidified after the re-melting through the electron beam irradiation or laser beam irradiation.

6. A spray coating member having an excellent injury resistance and the like according to claim 2, wherein the undercoat is a spray coating of 50-500 μm in thickness made from at least one metal or an alloy selected from Ni and an alloy thereof, Mo and an alloy thereof, Ti and an alloy thereof, Al and an alloy thereof and Mg alloy, or a cermet of such a metal or alloy with a ceramic.

7. A method of producing a spray coating member having an excellent injury resistance and the like, which comprises spraying a Al₂O₃ spraying powder material having a white color directly onto a surface of a substrate or onto a surface of an undercoat formed on the surface of the substrate, and then subjecting a surface of the thus obtained white Al₂O₃ spray coating to an electron beam irradiation or laser beam irradiation to change the color of the spray coating surface into an achromatic or chromatic color of a luminosity lower than grayish white.

8. A method of producing a spray coating member having an excellent injury resistance and the like according to claim 7, wherein a layer of less than 50 μm located inward from the surface of the white Al₂O₃ spray coating is changed into an achromatic or chromatic color of a luminosity lower than grayish white through the electron beam irradiation or the laser beam irradiation.

9. A spray coating member having an excellent injury resistance and the like according to claim 2, wherein the colored spray coating has a color formed by decreasing a luminosity of white color inherent to the spraying powder material or further changing hue and chromaticity to achromatic or chromatic color deeper than grayish white through electron beam irradiating treatment or laser beam irradiating treatment.

10. A spray coating member having an excellent injury resistance and the like according to claim 2, wherein the colored spray coating has a thickness of 50-2000 μm based on the deposition of Al₂O₃ spraying particles.

11. A spray coating member having an excellent injury resistance and the like according to claim 3, wherein the colored spray coating has a thickness of 50-2000 μm based on the deposition of Al₂O₃ spraying particles.

12. A spray coating member having an excellent injury resistance and the like according to claim 9, wherein the colored spray coating has a thickness of 50-2000 μm based on the deposition of Al₂O₃ spraying particles.

13. A spray coating member having an excellent injury resistance and the like according to claim 2, wherein a portion of the colored spray coating ranging from the surface to less than 50 μm is a layer solidified after the re-melting through the electron beam irradiation or laser beam irradiation.

14. A spray coating member having an excellent injury resistance and the like according to claim 3, wherein a portion of the colored spray coating ranging from the surface to less than 50 μm is a layer solidified after the re-melting through the electron beam irradiation or laser beam irradiation.

15. A spray coating member having an excellent injury resistance and the like according to claim 9, wherein a portion of the colored spray coating ranging from the surface to less than 50 μm is a layer solidified after the re-melting through the electron beam irradiation or laser beam irradiation.

16. A spray coating member having an excellent injury resistance and the like according to claim 4, wherein a portion of the colored spray coating ranging from the surface to less than 50 μm is a layer solidified after the re-melting through the electron beam irradiation or laser beam irradiation.

17. A spray coating member having an excellent injury resistance and the like according to claim 10, wherein a portion of the colored spray coating ranging from the surface to less than 50 μm is a layer solidified after the re-melting through the electron beam irradiation or laser beam irradiation.

18. A spray coating member having an excellent injury resistance and the like according to claim 11, wherein a portion of the colored spray coating ranging from the surface to less than 50 μm is a layer solidified after the re-melting through the electron beam irradiation or laser beam irradiation.

19. A spray coating member having an excellent injury resistance and the like according to claim 12, wherein a portion of the colored spray coating ranging from the surface to less than 50 μm is a layer solidified after the re-melting through the electron beam irradiation or laser beam irradiation.
